(19) United States
(12) Patent Application Publication
(10) Pub. No.: US 2019/0236976 A1
(43) Pub. Date: Aug. 1, 2019

(54) INTELLIGENT PERSONAL ASSISTANT DEVICE

(71) Applicant: RND64 LIMITED, Nicosia (CY)

(72) Inventors: Mykhailo HORBAN, Kharkiv (UA); Oleksandr MOROKKO, Kharkiv (UA); Volodymyr SHELEST, Kyiv (UA)

(73) Assignee: RND64 LIMITED, Nicosia (CY)

(21) Appl. No.: 15/885,795

(22) Filed: Jan. 31, 2018

(51) Int. Cl. G09B 19/00; G09B 5/06; G06N 5/02; H04R 1/02; G10L 15/22; G10L 15/30; H04R 1/40

(52) U.S. Cl. CPC G09B 19/0092; G09B 5/065; G06N 5/022; H04R 1/028; H04N 5/33; G10L 15/30; H04R 1/406; G10L 2015/223; G10L 15/22

(57) ABSTRACT

A consumer desktop product for use in a kitchen that can converse with and instruct a cook in the preparation and planning of meals. It is packaged in a large egg-shaped shell with a rounded bottom and has a very low center of gravity in one end so it can up on that end. The center of gravity can be manipulated with internal motors and gears such that the egg-shaped shell can be made to tilt fore and back, lean left and right, and even rotate. These actions are choreographed to give the Product an expressive personality that can endear and entertain its users. A portion of the upper hemisphere is dedicated to a display screen that is used to exhibit an animation of an eyeball to further endear and entertain the users. A principal use of the rear projection display screen is to show menus and recipes, and to assist in food preparation.

### FIELD OF THE INVENTION

The present invention relates to a multi-functional personal digital assistance device, primarily for use in a kitchen, that can converse with and instruct a user in the preparation and planning of meals. More specifically, the present invention is related to multi-functional personal assistant devices that operate based on speech recognition, artificial intelligence, and wireless Internet access.

### BACKGROUND OF THE INVENTION

Artificial intelligence (AI) is a major scientific advance now delivering huge technology rewards in manufacturing, military, automobiles, virtual reality, and other highly technical industries, and now in homes and kitchens. Constant access to the Internet makes large expensive AI processors available as servers to do jobs off-loaded from even simple desktop devices in consumers' homes.

Computers and digital assistants that can respond to user voice commands and inquiries are now using advanced artificial intelligence methods to engage users in natural speech. This makes it possible for users to verbally pose questions and get intelligent and useful answers spoken in response. New devices like the Amazon Echo, Alexa, and Show are able to play music requests, turn on lights, give weather forecasts, and many other skills.

These new devices depend on constant wireless Internet access in order to have access to the kind of artificial intelligence processing needed to parse and understand verbal user commands and inquiries, and access to the wide variety of encyclopedic sources, recipes, cookbooks, music, video, Internet website, and the vast community online.

The primary function of the multi-functional intelligent personal assistant device of the present invention is to provide cooking assistance via step-by-step voice-navigated recipe video tutorials. However, real-time prompts from a human support team for those who might need a little more hand-holding in the kitchen is contemplated and is available as an additional function of the personal assistant device of the present invention. Among the aforementioned functions, the personal assistant device of the present invention is capable to concurrently maintain a lively conversation with the user, express itself through mimicking facial expressions, and keep the user entertained by providing the user with an on-demand and instant access to various music streaming services such as Spotify, Deezer, Google Play All Access, Grooveshark, Last.fm, Pandora Radio, and etc., as well as audio news feeds, and weather forecasts. Finally, the multi-functional intelligent personal assistant device includes voice-activated timers and reminders which are delivered to the user according to the user's preference, such as by the device's own speech, playing of a selected music, sound of an alarm, and etc.

### SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

Throughout this disclosure, unless the context dictates otherwise, the word “comprise” or variations such as “comprises” or “comprising,” is understood to mean “includes, but is not limited to” such that other elements that are not explicitly mentioned may also be included. Further, unless the context dictates otherwise, use of the term “a” may mean a singular object or element, or it may mean a plurality, or one or more of such objects or elements.

The multi-functional intelligent personal assistant device of the present invention includes a consumer desktop product that can converse with and instruct a user in the preparation and planning of meals. It is packaged in a large egg-shaped shell with a rounded bottom having a low center of gravity such that the device is always able to eventually assume an upright position. The center of gravity can be manipulated with internal motors and gears such that the egg-shaped shell can be made to tilt and even rotate. These actions are choreographed to give the device an expressive personality that can endear and entertain its users. A portion of the upper hemisphere of the egg-shaped device is dedicated to a visual display screen that is used to exhibit an animation of an eyeball to give lifelike personality to the personal assistant device and to further endear and entertain the users. A principal use of the visual display screen, however, is to display menus, recipes, and videos to the users related to food preparation.

The multi-functional intelligent personal assistant device responsive to spoken requests for assistance and information from a user, comprising an egg-shaped main body having a shell that encloses inside at least one microcomputer, audio subsystem, video display subsystem, sensor subsystem, movement control electro-mechanical subsystem, internal bus, battery, battery charger, wireless transceiver that supports connections with the Internet, and plurality of interconnections, wherein the main body has a rounded bottom end and a low center of gravity in the bottom end so as to assume an upright position when leveled, wherein the movement control electro-mechanical subsystem is operative to respond to control of the microcomputer and includes accelerometer or similar sensors allowing to detect tilt (the device position relating to vertical axis) and may include at least one rotation control system and at least one tilt control system, wherein the rotation control system enables the device to rotate on its axis and the tilt control system enables the device to tilt left, right, fore and aft, wherein the rotation control system includes at least one rotation motor mounted to at least one rotor ring and a set of gears to rotate the device on its axis; wherein the tilt control system includes at least a pair of sliding gear motors and at least a pair of ballast weights to tilt the device left, right, fore and aft by manipulating a center of gravity (COG) of the main body of the device, and wherein the sensor subsystem includes at least one user detection system having a plurality of passive infrared sensors (PIT).

The multi-functional intelligent personal assistant device further comprising at least one microphone and at least one speaker included in the audio subsystem, wherein at least one microphone is operative to receive spoken words from the user, and at least one speaker is operative to produce verbal responses, music, and sounds to the user, wherein words and phrases spoken by the user are recorded into audio files by the microcomputer and audio subsystem, and then transmitted wirelessly to servers on the Internet for understanding and responding back to the user using artificial intelligence (AI) processors and commercial application program interfaces (API).

The multi-functional intelligent personal assistant device, further comprising an animation program control of the microcomputer that causes real-time visual changes of the device to be displayed to the user, wherein the visual changes comprise a cartoon animation shown on the video display of the device, and may change to the COG of the device such that the device tilts left, right, fore or aft.

The multi-functional intelligent personal assistant device further comprising a video display program control of the microcomputer that transmits digital pictures, graphics, text, photos, and/or videos through the video display subsystem as a response to a spoken command of the user.

The multi-functional intelligent personal assistant device further comprising the COG of the main body is within two to three centimeters from a bottom end of the device and is such that the whole stands up at attention on the bottom end when laid on a flat surface, and wherein, the COG may be adjustable under program control of the microcomputer through the movement control electro-mechanical subsystem.

The multi-functional intelligent personal assistant device further comprising a plurality of passive infrared sensors (PIR) and a plurality of far-field microphones that are dispersed around the circumference of the device, and at least one pinhole camera with infrared cut-off filter (IR filter).

The multi-functional intelligent personal assistant device further comprising a speech recognition sorter that redirects speech recognition requests and audio files to a human concierge whenever artificial intelligence fails a speech recognition task.

### SUMMARY OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a diagram of a personal cooking assistant device on a countertop and showing an animated eye on its internally projected display;

FIG. 2 is a side elevation diagram of the device of FIG. 1 showing dimensions and weights typical of a prototype that was tested;

FIG. 3 is a functional perspective view diagram of the device of FIG. 1 with an alternative camera;

FIG. 4 is a functional perspective view diagram of the outer polycarbonate shell of the device of FIG. 1 with an alternative camera and outlining where the internal digital video projector display screen is positioned;

FIG. 5A is a cross sectional diagram of the device of FIG. 1 representing the relationships between the DLP projector module, mirror, display screen, and user;

FIG. 5B is a perspective view diagram of the upper outer polycarbonate shell of the device of FIG. 1 and FIG. 5A;

FIG. 6A is a schematic diagram of the device of FIG. 1 showing the relative placement of components of the rotation control system;

FIGS. 6B-6D are perspective view diagrams of structural pieces of the device of FIG. 1, and for the rotation control components of FIG. 6A, the wireless charger and bottom;

FIGS. 7A and 7B are perspective view diagrams of the front and of the back of the device of FIG. 1 without the external polycarbonate shells in place;

FIGS. 8A and 8B are schematic diagrams of the X-axis and Y-axis tilt control motors, gears, and slide rods as observed from the front in FIG. 8A and from above in FIG. 8B;

FIGS. 8C and 8D are perspective view diagrams of the X-axis and Y-axis tilt control motors, gears, and slide rods (of the schematic FIGS. 8A and 8B) as observed from the above to show the X-axis components in FIG. 8C and from below to show the Y-axis components in FIG. 8D;

FIG. 9 is a diagram of the phased audio signals that the four far-field microphones in an array around the device of FIG. 1 will receive and how in the graphs section such signals are phased summed into a single higher quality product;

FIG. 10 is a diagram that looks down on a device like that of FIG. 1 to illustrate how four passive infrared sensors distributed about its circumference can provide detection of a user's relative location;

FIG. 11 is a functional block diagram of the microcomputer, audio, display, sensor, and movement control electro-mechanical systems of the device of FIG. 1; and

FIG. 12 is a schematic diagram showing the communication schema of the device of FIG. 1 that is employed to access remote artificial intelligence and API speech services from the Internet in order to understand and respond to a user's spoken words.

### DETAILED DESCRIPTION OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

Embodiments of the present invention include a voice-operated smart assistant with a screen display and an expressive, lifelike personality designed primarily to assist a user with food preparation in a kitchen. Such assistance is provided by the device by its ability to recognize user's commands, and, in response, provide step-by-step voice-navigated recipe video tutorials, music streaming, audio news feeds, weather forecasts, as well as multiple voice-activated timers, and reminders.

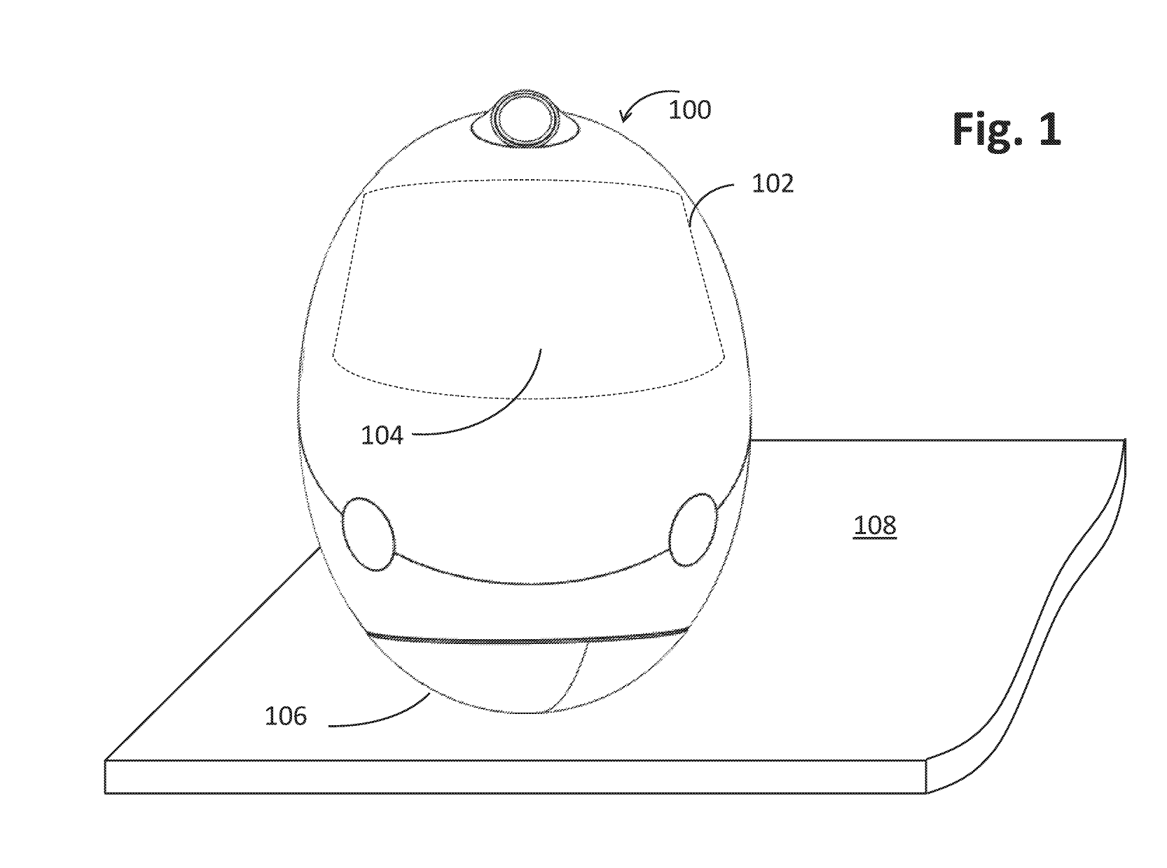

FIG. 1 represents an egg-shaped multi-functional personal digital assistant 100 that includes a visual display screen area 104 which can display a cartoon animation 104, e.g., a winking, blinking, squinting, and etc. eye. The personal digital assistant 100 is generally in the shape of an egg standing on one end 106, and typically operated on a relatively flat surface, e.g., kitchen countertop 108. The personal digital assistant 100 responds to spoken user commands and can voice verbal responses to the user. In one embodiment, these voice communications help the user prepare foods from recipes.

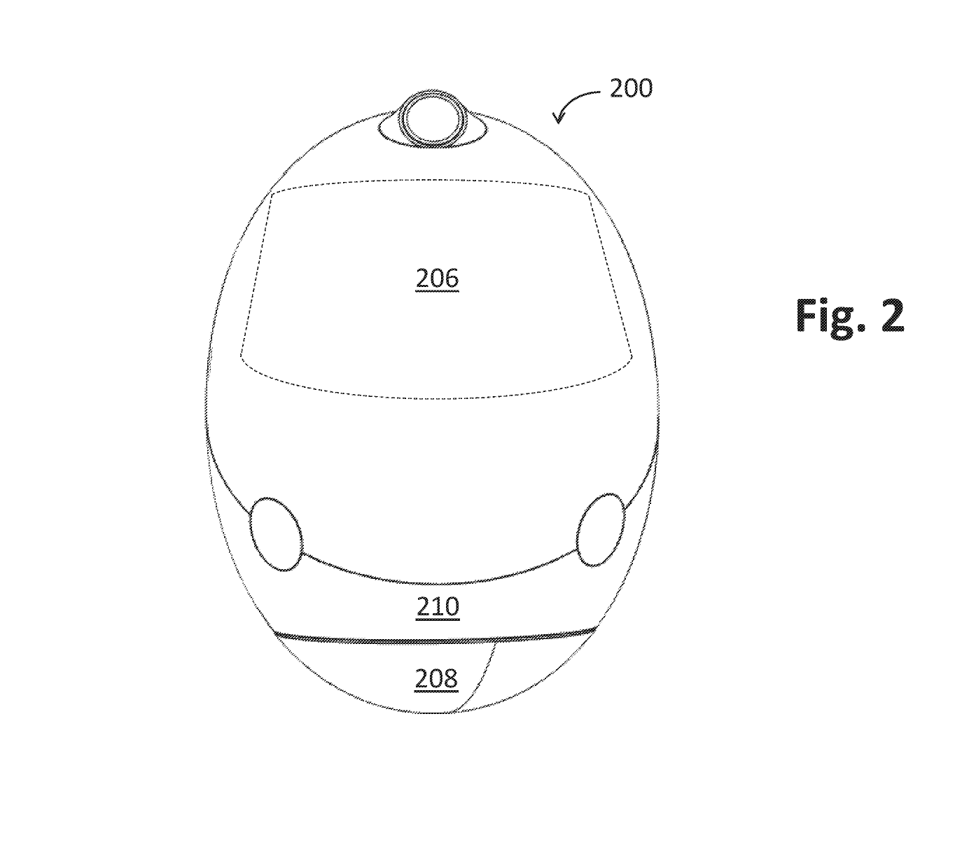

FIG. 2 represents the useful dimensions of a typical egg-shaped personal digital assistant 200. Its height 202 is about 7.8″, its waist width is 5.5″, and that allows for a rear projection screen display 206 of 5.5″. A bottom 208 can rotate under motor power in relation to the top and has a rubberized surface. Such top is a transparent gray, hollow polycarbonate shell 210. A typical weight is 2.9 pounds.

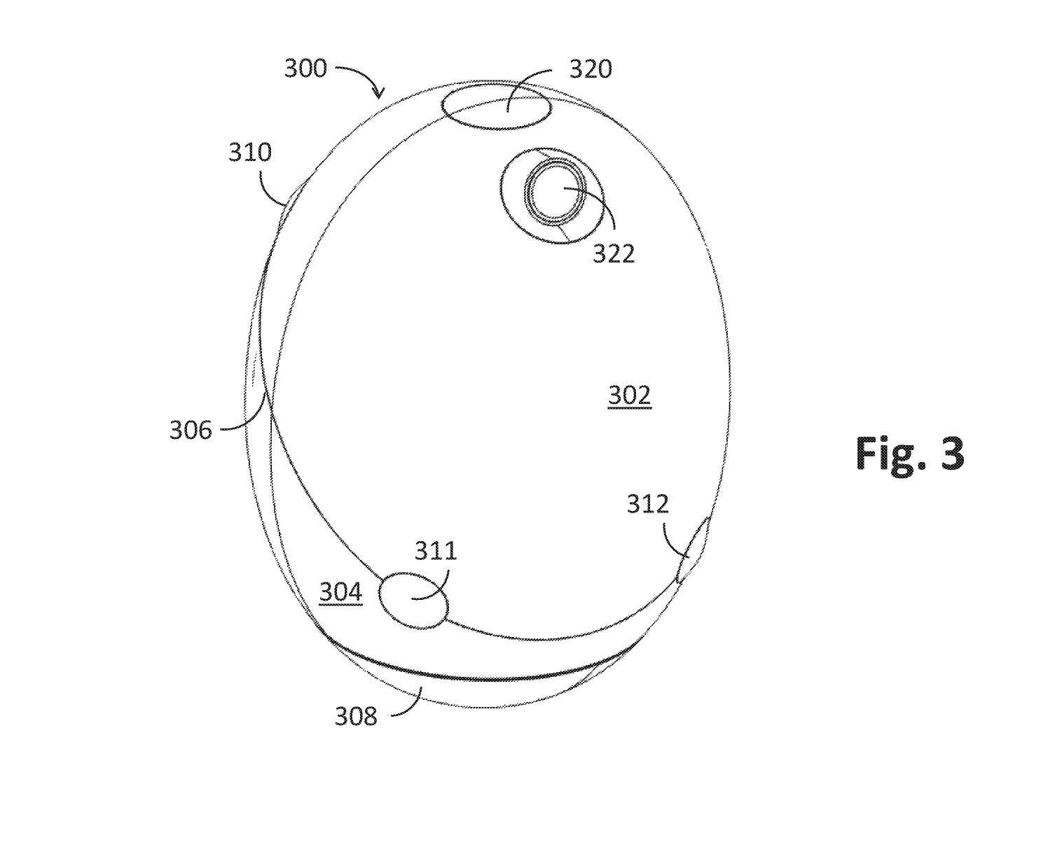

FIG. 3 represents a prototype 300 for packaging personal digital assistants 100 and 200. A top main housing 302 joins a bottom main housing 304 along a radial parting line 306. A rounded bottom 308 allows the prototype 300 to rock and tilt by the way of motorized manipulations of the center-of-gravity (COG) of the device. As such, in order to stand the prototype 300 upright on its bottom end 308, the COG (as an imaginary point in space) will be within the volume of bottom main housing 304 and evenly positioned within the rounded bottom end 308. For example, only 2-3 cm from the bottom. Ballast weights can be added to lower the COG if needed. A lithium 4-cell 35W battery capable of delivering 10A at 3.7V may be needed, and since batteries are generally heavy, its placement critically effects the COG of the device. Further, the device of the claimed invention could operate wirelessly by utilizing electrical charge of a lithium battery within the device or by being plugged directly into an electrical outlet, as a power source, by an electrical wire, cable, cord, and etc. Additionally, the battery within the device could either be re-chargeable or non-rechargeable lithium or alkaline battery.

A number of passive infrared sensors (PIR) and far-field microphones 310-312 are dispersed around the circumference and used to sense where the user is and to better capture and recognize what the user is saying. A capacitive sense control button 320 is configured as a soft button to take on a variety of different control functions of the device. A main pinhole camera with Infrared cut-off filter (IR filter) 322 permit the user to be imaged and located. In one embodiment, the rounded bottom 308 is automatically turned by an internal motor and gear so that the front and pinhole camera 322 face the user.

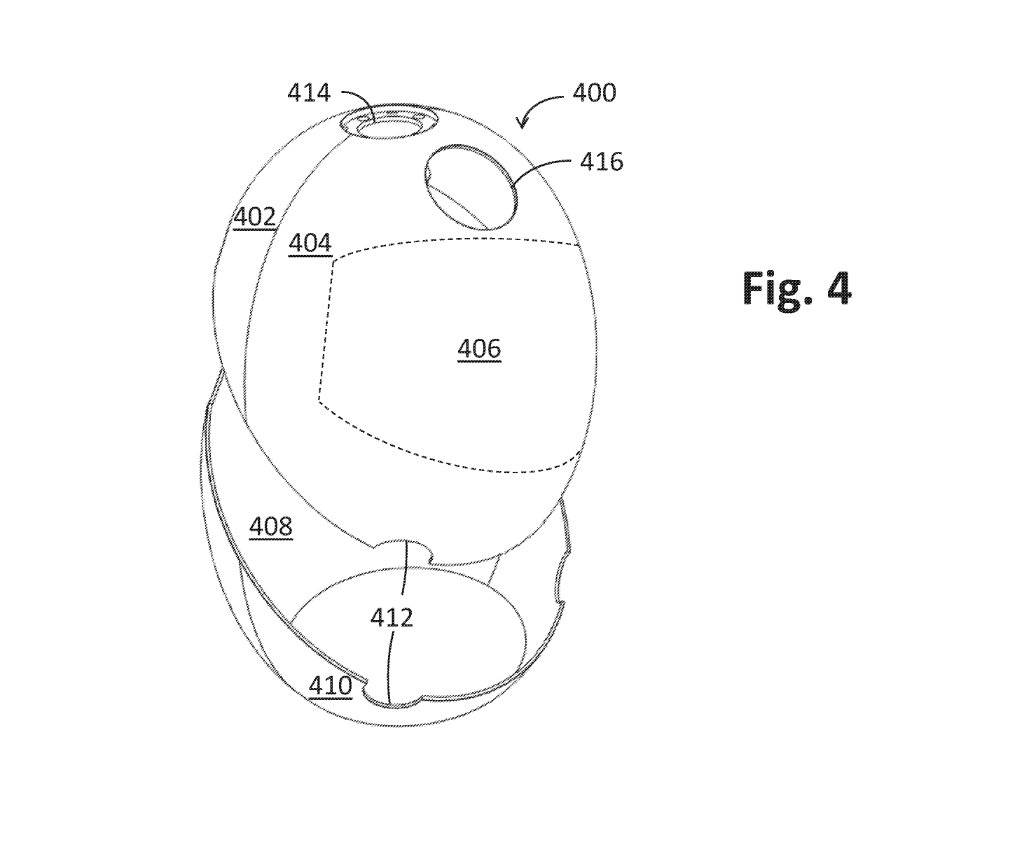

FIG. 4 is similar to FIG. 3, but only shows an external multi-part transparent housing 400 in dark gray polycarbonate (e.g., LEXAN). The housing 400 includes a top rear part 402, a top front part 404 with screen area 406, a bottom rear part 408, and a bottom front part 410. Four pairs of half-round notches, represented by notch pair 412, surround the device and provide for four passive infrared sensors. A capacitive sense control button recess 414 is configured to receive a switch. Another hole 416 can be used for a pinhole camera.

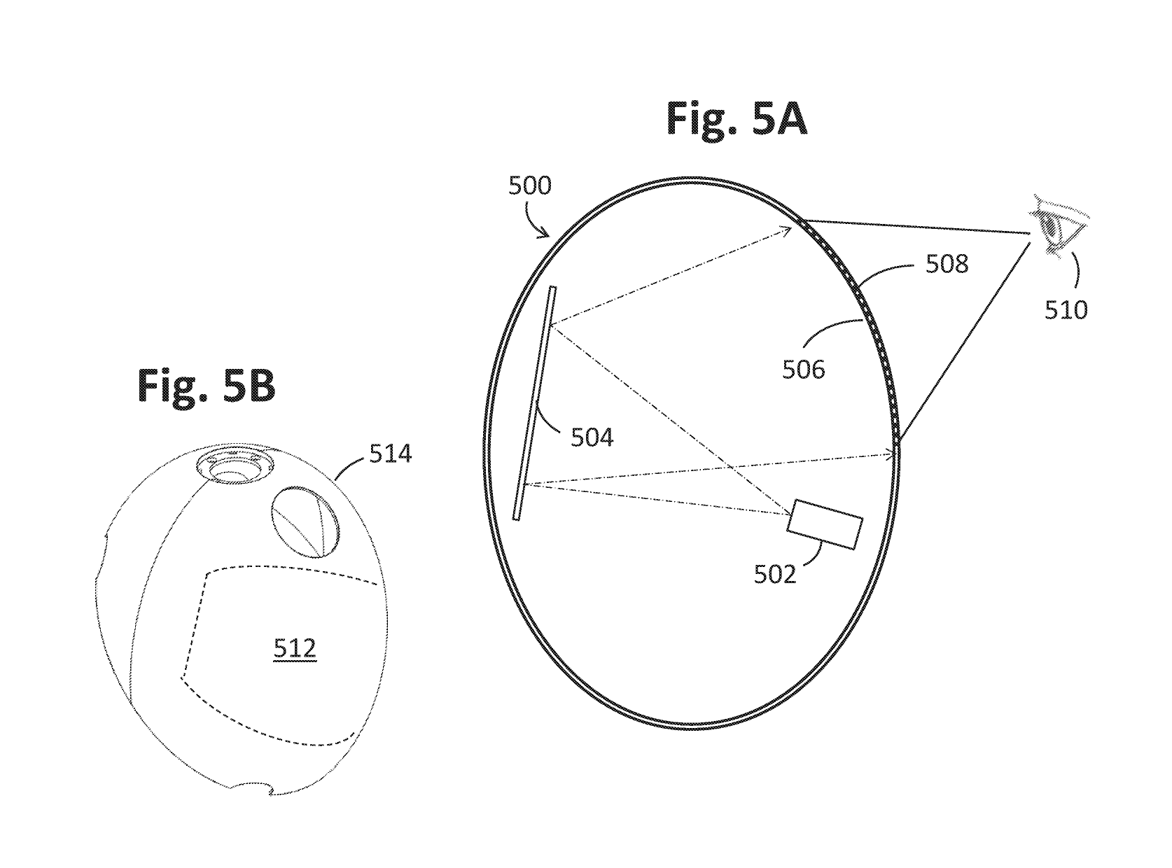

One of the embodiments of the present invention contemplates the use of a digital light processing (DLP) projector system to display an image on the display screen for the user, as shown in FIGS. 5A and 5B. FIGS. 5A and 5B represent a DLP projector system 500 as can be used in the foregoing devices of FIGS. 1-4. A DLP module 502 receives a video signal from an embedded microcomputer, and projects an image that is then reflected by a minor 504 onto a display screen 506 painted on the backside of an outer clear polycarbonate shell 508. There, the projected image is viewable by a user 510. There are a number of alternative technologies that can be successfully used within the device of the present invention to project an image on the display screen of the device, such as, liquid crystal on silicon (LCoS), liquid crystal display (LCD), Ultra Short Throw Projector, Circular Fisheye Projection, Full-Frame Fisheye Projection and etc. Thus, there are no reflective mirrors within the device to project an image onto a display screen where the alternative display technologies are utilized. Furthermore, those of skill in the art will appreciate that the projection screen display of the device of the present invention is not limited to the exemplary dimensions provided herein. For example, use of certain projection technologies (e.g. ultra-short throw or fisheye) will enable and/or necessitate the display screen of the device to occupy as much as an entirety of the upper half of the body of the egg-shaped device. Skilled persons can implement the described functionality in varying ways for each particular application, but such implementation decisions should not be interpreted as causing a departure from the scope of the invention.

In one embodiment, the video images projected onto display screen 506 include cartoon animations of an eyeball, recipes, instructional how-to videos, etc. The display screen 506 is confined by a cutout 512 in an upper inner shell 514, such as above PIR sensors 311 and 312 in shell 302 of FIG. 3.

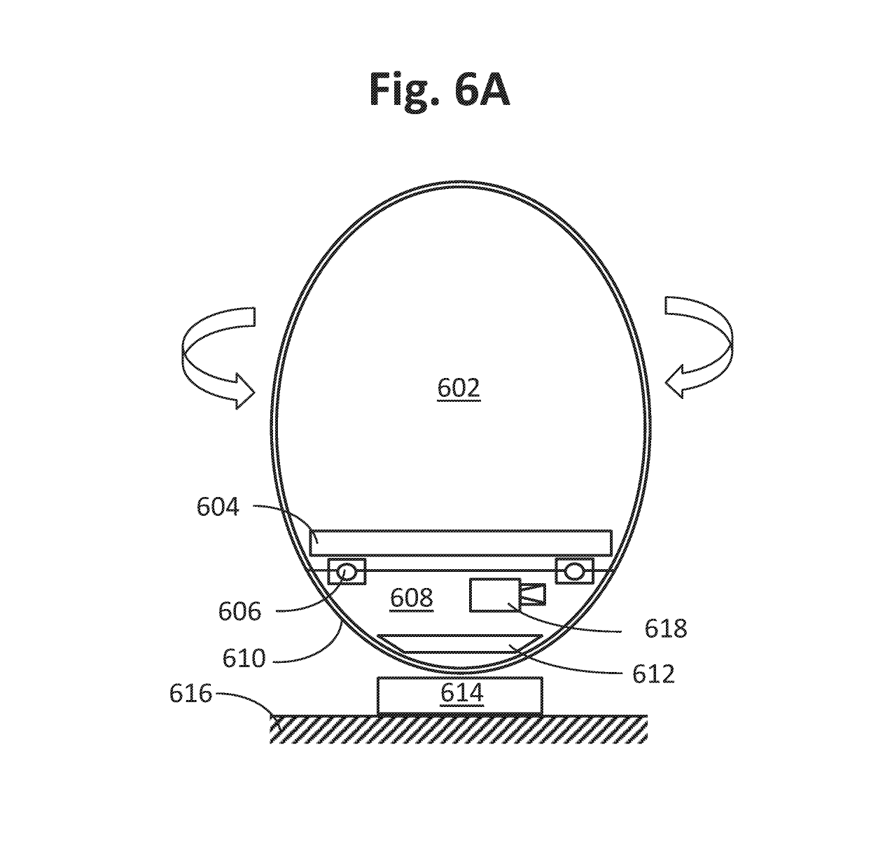

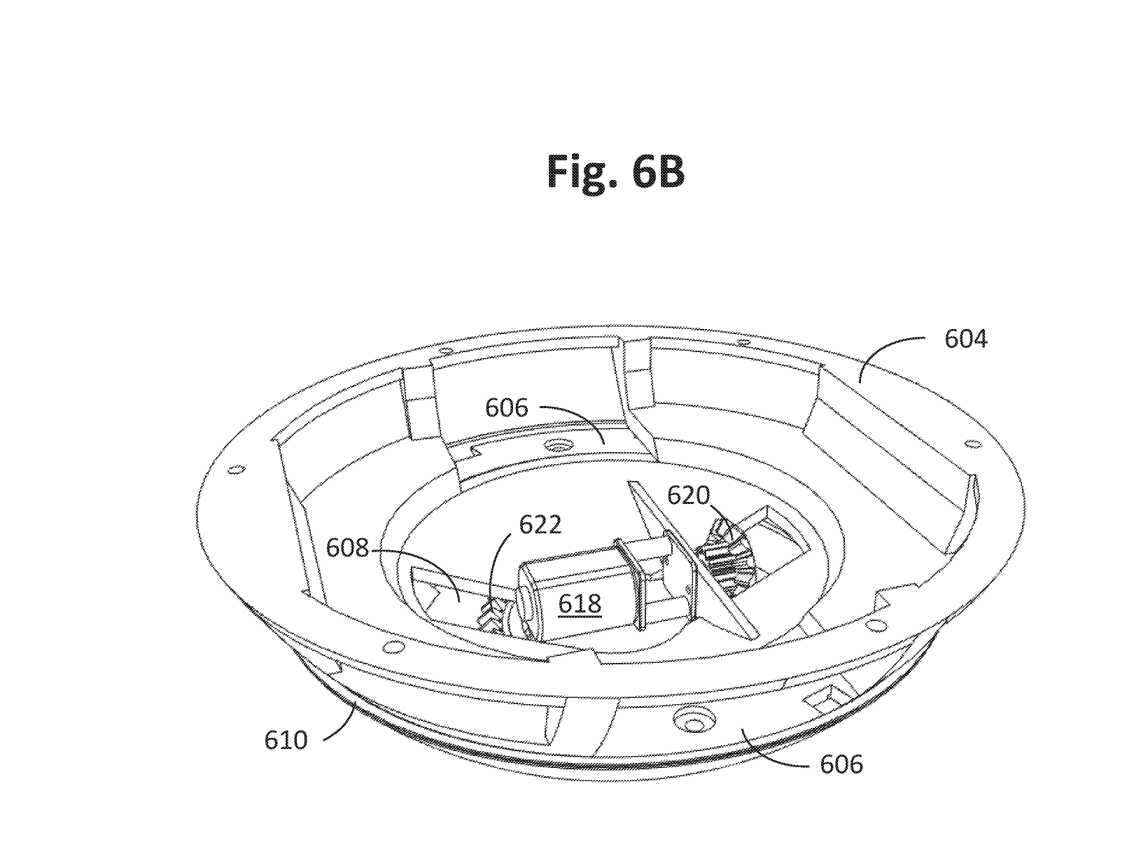

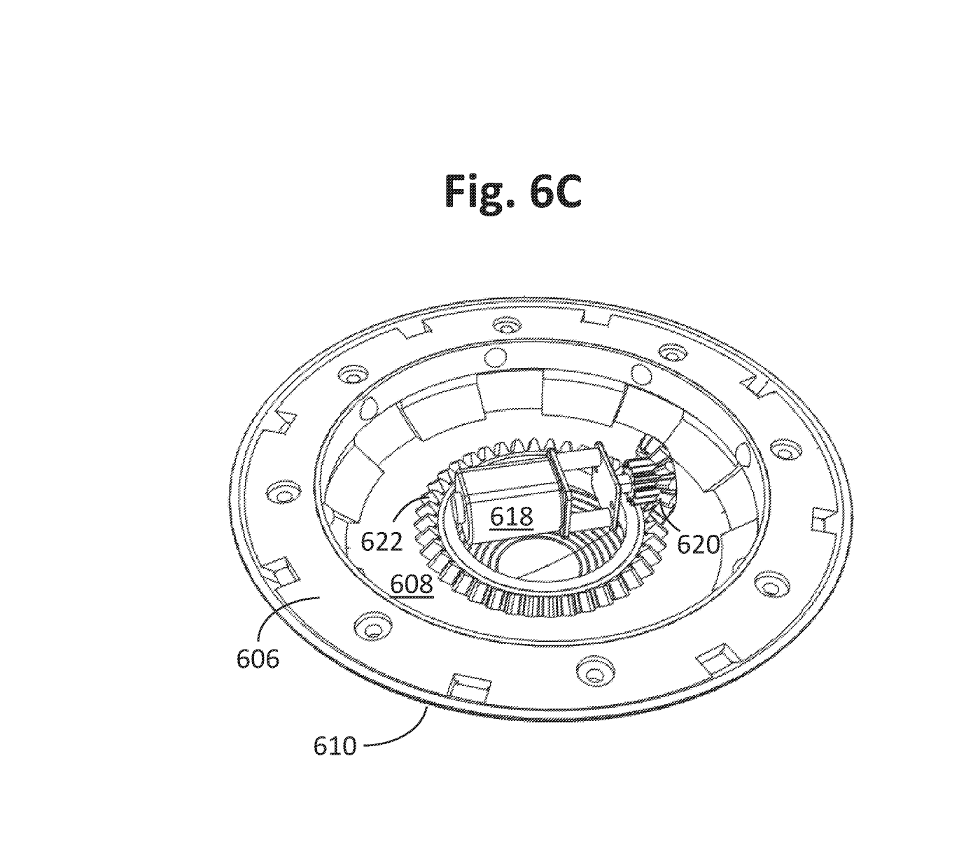

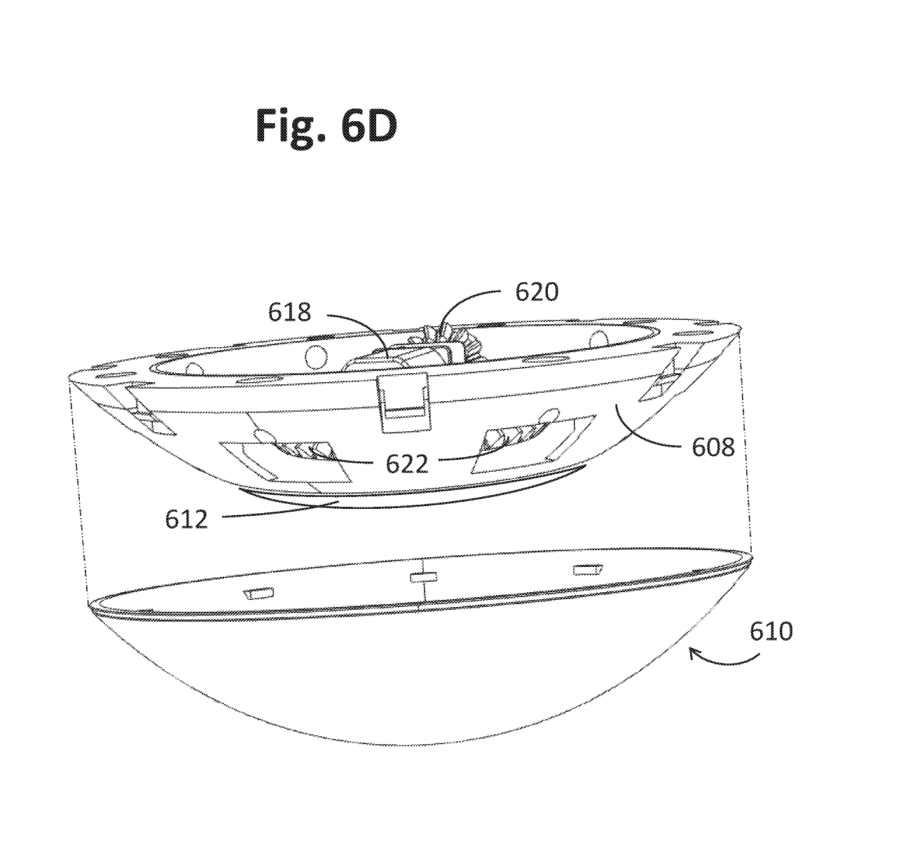

FIGS. 6A-6D represent how a device 600 like those of FIGS. 1-4 can be mechanized to rotate on its axis. One of the benefits of this function is so the device 600 can turn to “face” a user, i.e. the user is able to view the display at any point in the room. Other benefits include better capturing of the user's voice commands as well as it adds yet additional lifelike feature to the personality of the device. An upper body 602 supported by a rotor ring 604 are what actually can turn on a ball-bearing ring plate 606. The ball-bearing ring plate 606 fits inside a stationary base 608 and snap-on bottom cover 610. A wireless charger includes a pickup coil 612 and a charger induction unit pedestal 614. The whole sits atop, e.g., a kitchen counter 616. A motor 618 mounted to the rotor ring 604 has a planetary gear 620 that drives a sun gear 622 on the stationary base 608.

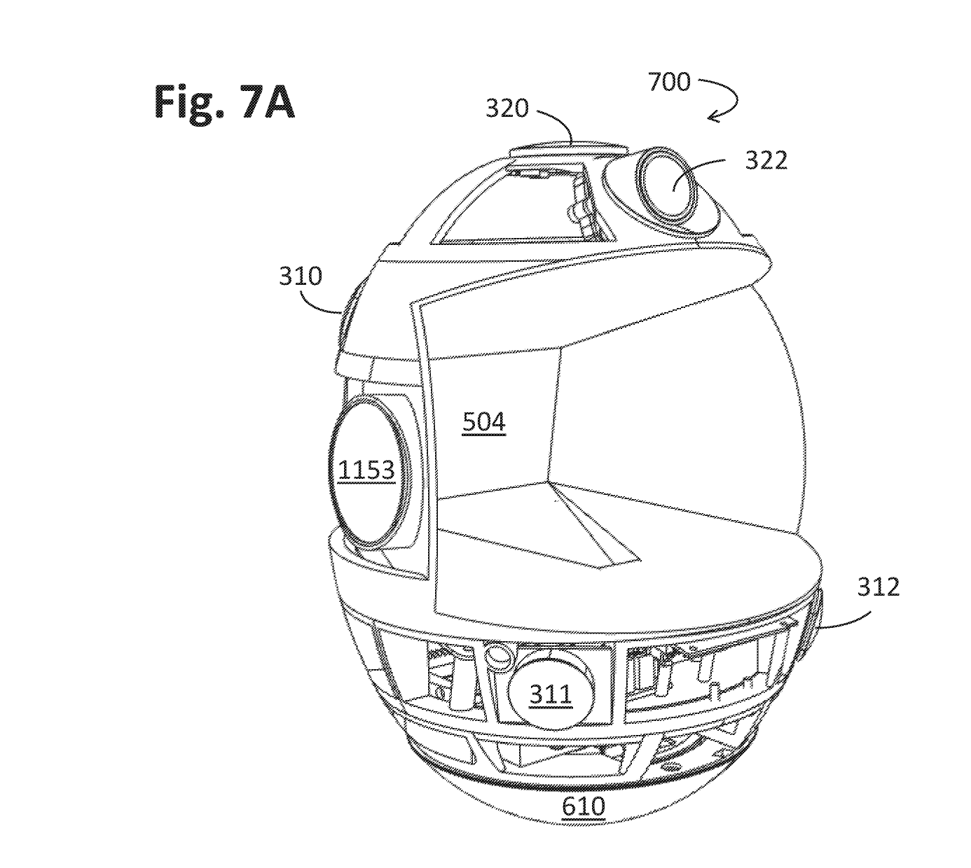

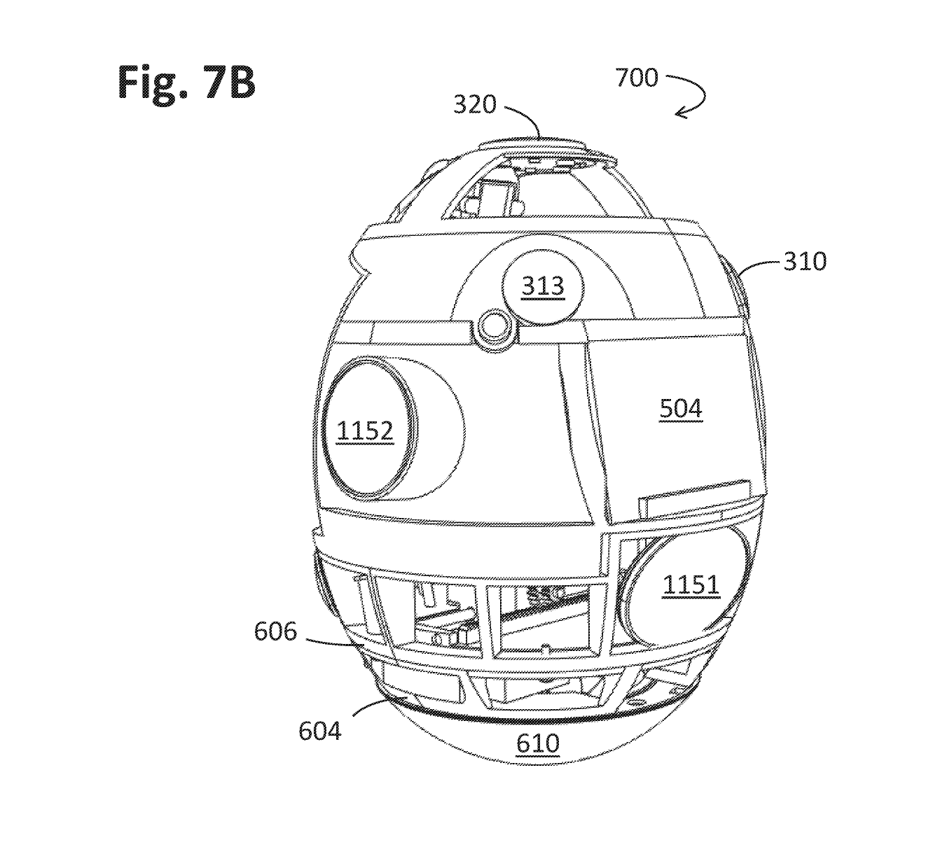

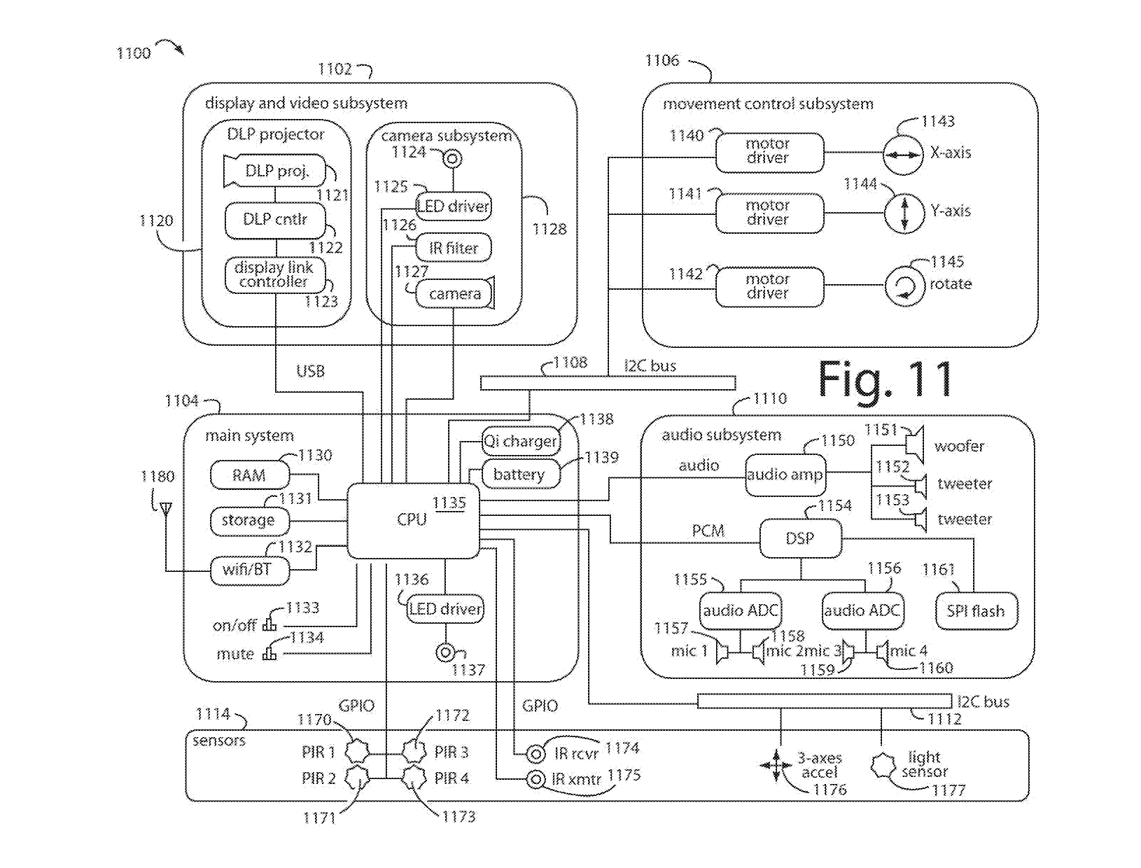

FIGS. 7A and 7B represent a device 700 like that of FIG. 1 but with the external polycarbonate shell removed for purposes of this description. It should be evident from FIG. 7A that the upper volume of device 700 is mostly empty air. These spaces are used for one of the aforementioned projection technologies inside the device to project images onto the display of the device. For illustration purposes only, if DLP technology is used, the space of the upper volume is utilized for the DLP Projector to project and reflect images internally on minor 504. The whole device 700 is able to turn and rotate on bottom 610, e.g., to turn and face the display screen toward the user. A woofer 1151 (FIG. 11) is set in the back in FIG. 7B, and left and right stereo tweeters 1152 and 1153 are set on left and right sides of device 700.

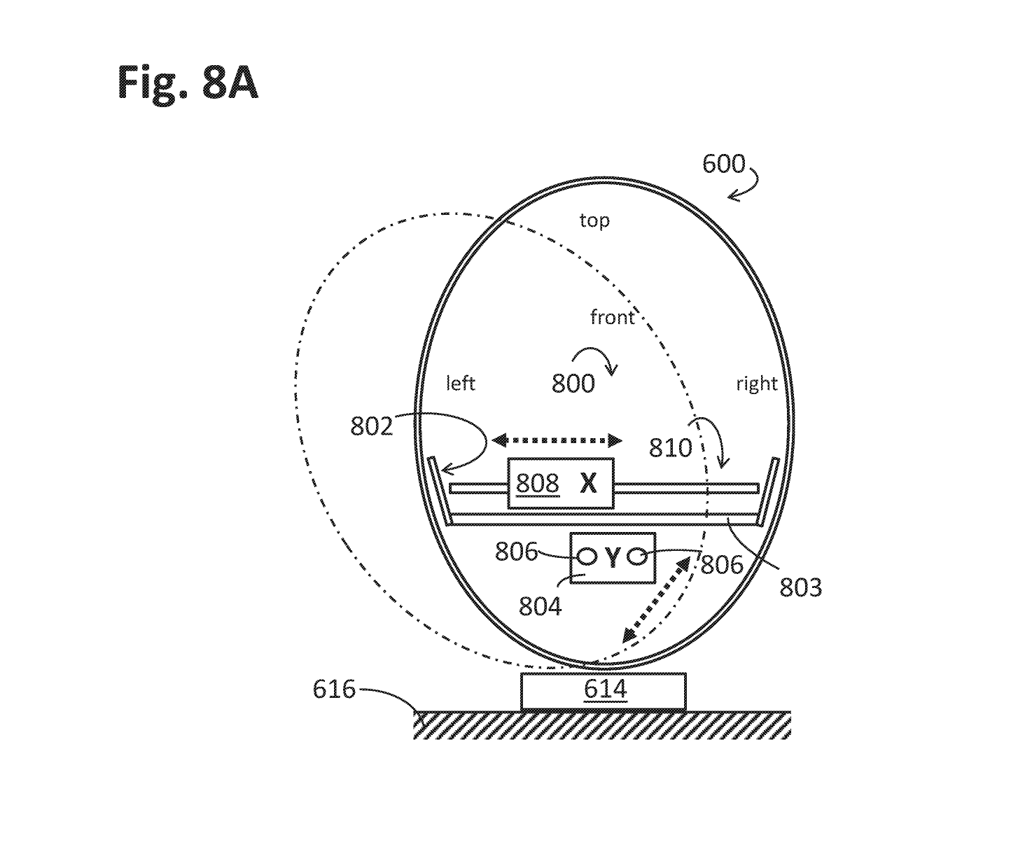

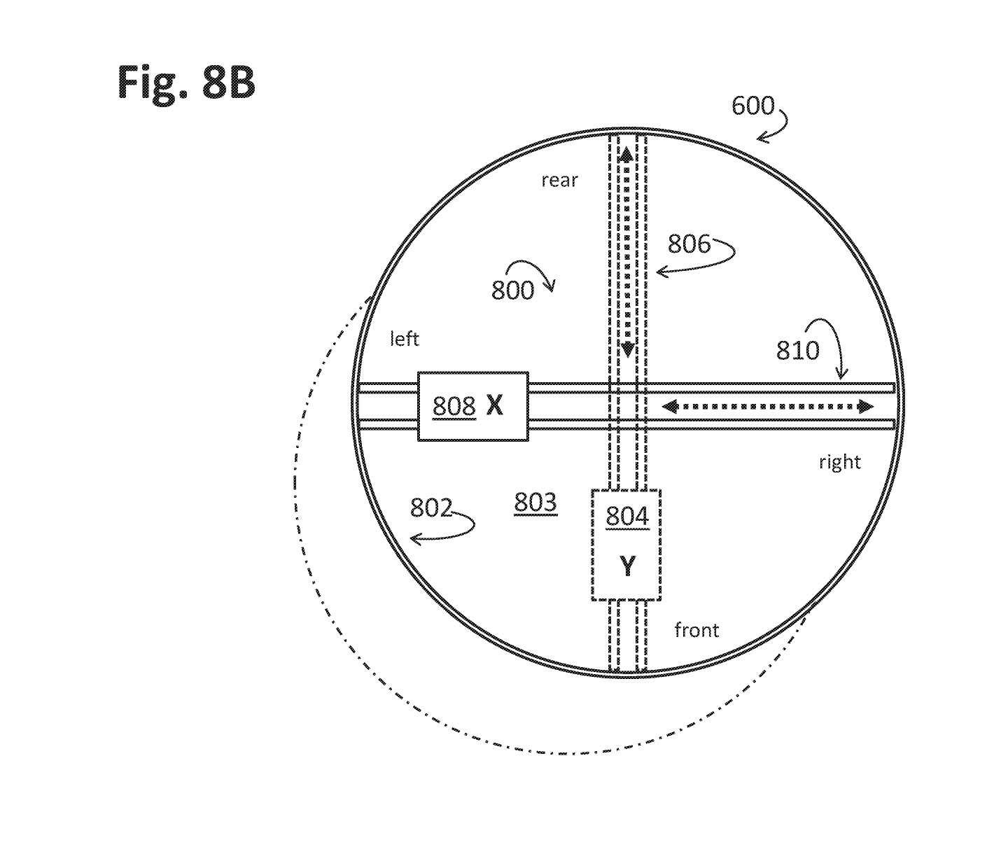

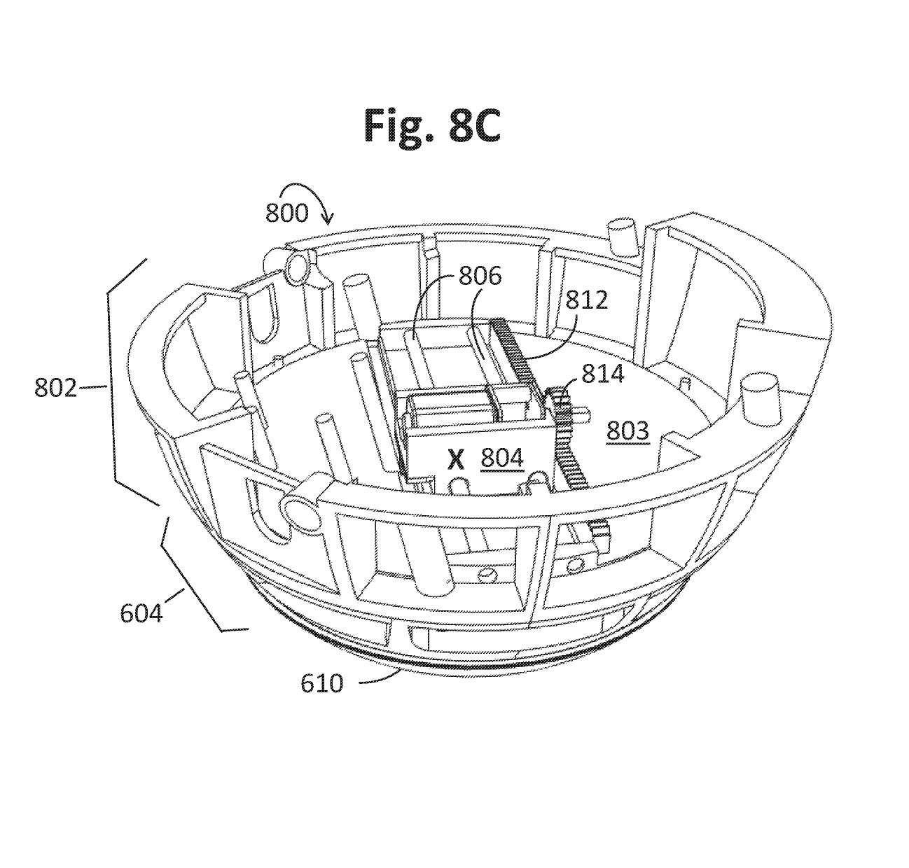

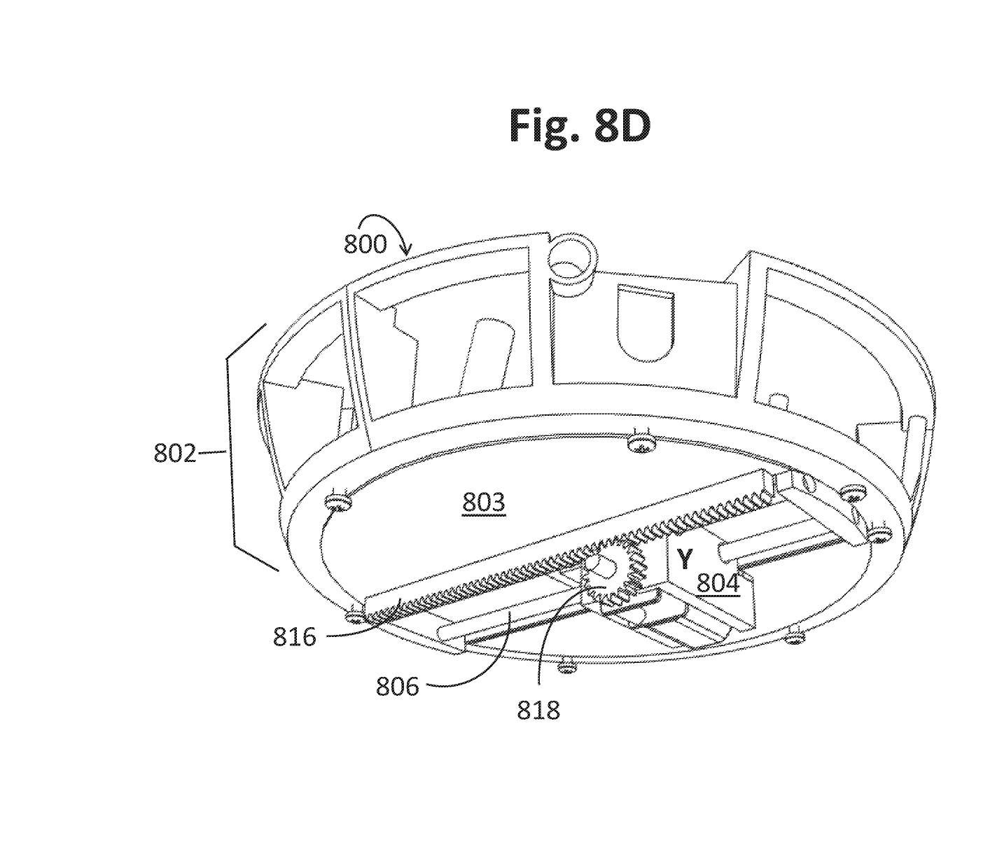

Turning now to FIGS. 8A-8D, device 600 can be further mechanized by a tilt control system 800 to tilt device 600 left and right, fore and aft on its round bottom by manipulating the center-of-gravity (COG) with repositionable ballast weights. One object of such ability is to impart an expressive personality for the user to observe, e.g., by moving while talking.

A bowl-shaped mezzanine frame 802 with a flat floor 803 carries a sliding Y-axis gear motor and ballast weight 806 above floor 804 on fixed slider rods 806. Similarly, a sliding X-axis gear motor and ballast weight 808 below floor 804 on fixed slider rods 810. Not shown in FIGS. 8A and 8B are the motor gear pinions and rack gears they respectively engage. The bowl-shaped mezzanine frame 802, in turn, fits atop rotor ring 604 (FIG. 6). The device of the present invention also contemplates the use of motion sensors (accelerometers) to detect and control the tilting function of the device.

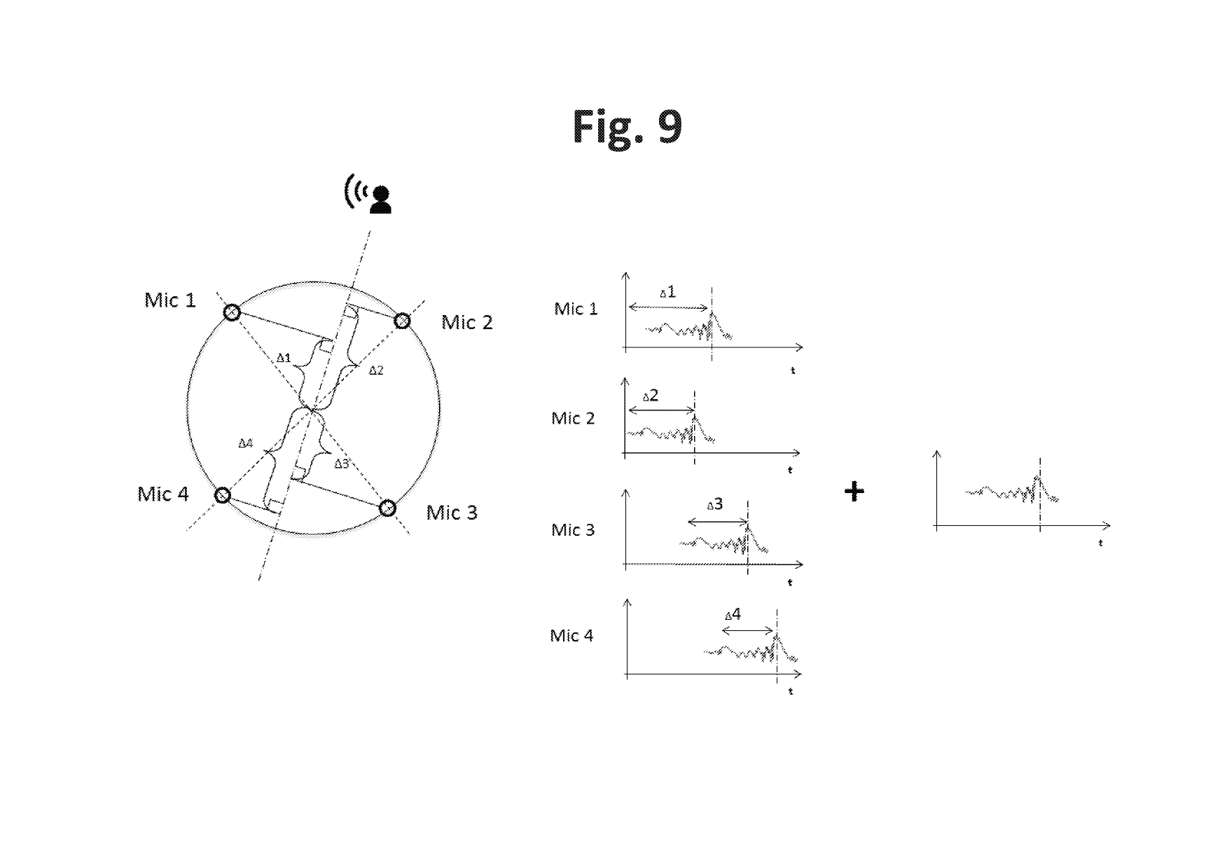

FIG. 9 represents a microphone array 900 that comprises four microphones 310-312 distributed around the circumference of devices like 100, 200, 300, 600, etc. Sounds from a sound source at different phases of time that can be processed and phase summed together to improve the far-field pickup.

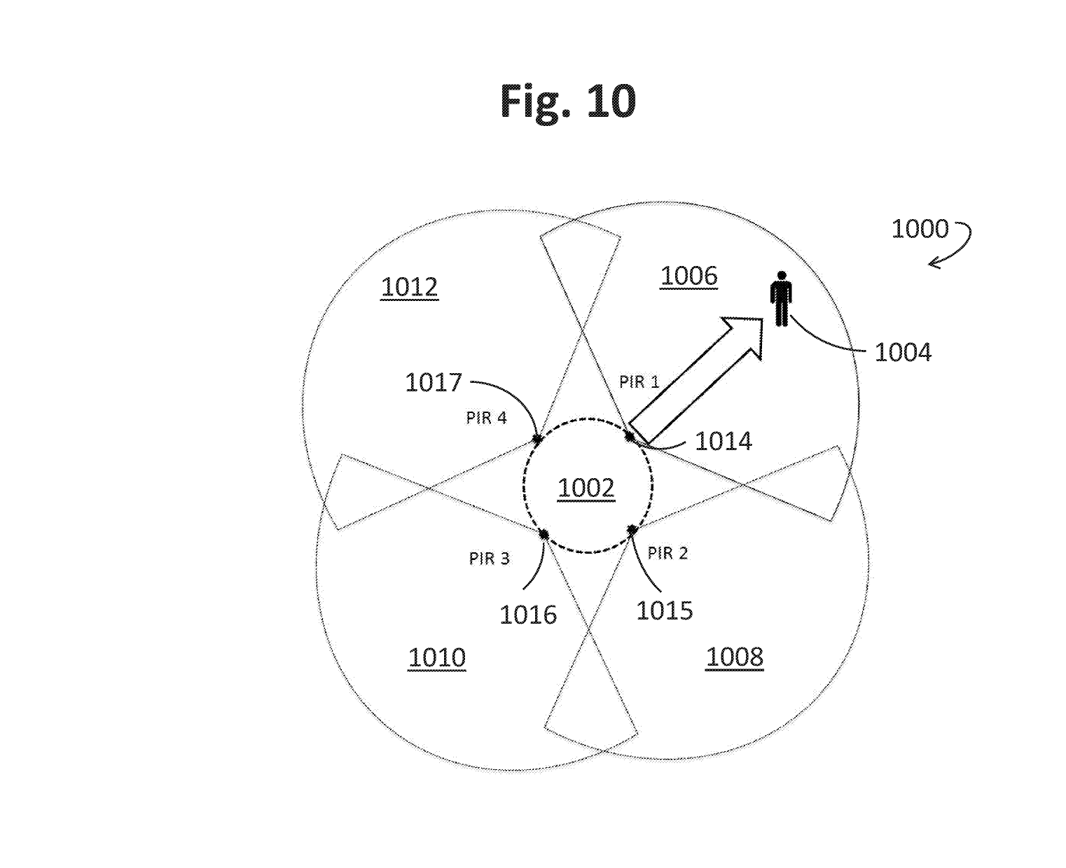

FIG. 10 represents a user detection system 1000 that allows a device 1002 to detect a user 1004 in one of four surrounding zones 1006, 1008, 1010, and 1012. Each such zone is instrumented with a corresponding passive infrared sensor (PIR) 1014-1017 more or less equally distributed around the circumference of device 1002. One use for these is to detect which direction a user is present and then to turn device 1002 to turn to face the user 1004 with the display screen 102 (FIG. 1), 206 (FIG. 2), 406 (FIG. 4), 506 (FIG. 5), etc.

FIG. 11 represents a hardware design for a microcomputer system 1100 useful in embodiments of the present invention as shown in FIGS. 1-10. Such comprises a display and video subsystem 1102, a main system 1104, a movement control subsystem 1106, an I²C bus 1108, an audio subsystem 1110, another I²C bus 1112, and a group of sensors 1114. “I²C” stands for Inter-Integrated Circuit and is a multi-master, multi-slave, packet switched, single-ended, serial computer bus.

An antenna 1180 is provided for Bluetooth low energy (BLE) and WiFi wireless communication with transceiver 1132. Wireless is the primary way Internet connectivity is supported.

The software needed for the various embodiments includes a cloud application and device firmware. The cloud application provides an applications programming interface (API) to work with the hardware of FIG. 11, logic to work with artificial intelligence (AI) providers, logic to transfer information to support agents, and storage for user profile information like social network access, PayPal authentication tokens, etc. Device firmware includes an interface between the Cloud Application and the end user. It manages the microphones, speakers, camera and show information on screen.

Embodiments of the present invention may leverage various external AI service providers such as IBM (IMB Watson), Google (Tensor Flow) and Microsoft (Azure), and etc. to enable the device of the present invention to converse with a user. For example, the IBM Watson Speech to Text service uses speech recognition capabilities to convert Arabic, English, Spanish, French, Brazilian Portuguese, Japanese, and Mandarin speech into text. The transcribing of audio begins with using the microphones to record an audio file, e.g., Waveform Audio File Format (WAV), Free Lossless Audio Codec (FLAC), an audio coding format Opus, and etc. The API can be directed to turn on and recognize audio coming from the microphone in real-time, recognize audio coming from different real-time audio sources, or to recognize audio from a file. In all cases, real-time streaming is available, so as the audio is being sent to the server, partial recognition results are also being returned. The Speech to Text API enables the building of smart apps that are voice triggered.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

Operation Model (business operation, process sheets):

1. Customer talks<1.a
a. Device do on-board recognition to find out if customer refers to assistance. ?<1.b :<1
b. device sends raw voice track to server-side>2.a

2. Server side use one+AI services to recognize what customer wants>2.a
a. if the question is recognized, and there is a high matching score to a device action ?>4
b. if the question is recognized and some external action is matched, the action will be executed, and result passed as response ?>4
c. if the question is recognized, and no action found, or action has low matching score, the question is sent to HumanAssistance>3

3. Human Assistance receives new/reopened chat together with any last message from customer >3.a
a. possible actions will be given to operator.>3.b
b. operator select one or writes their own response. >3.c
c. the response is returned to the server>4

4. Text-to-speech processor generates an audio file>4

5. Device plays the audio
a. shows picture if one exists
b. start action if needed

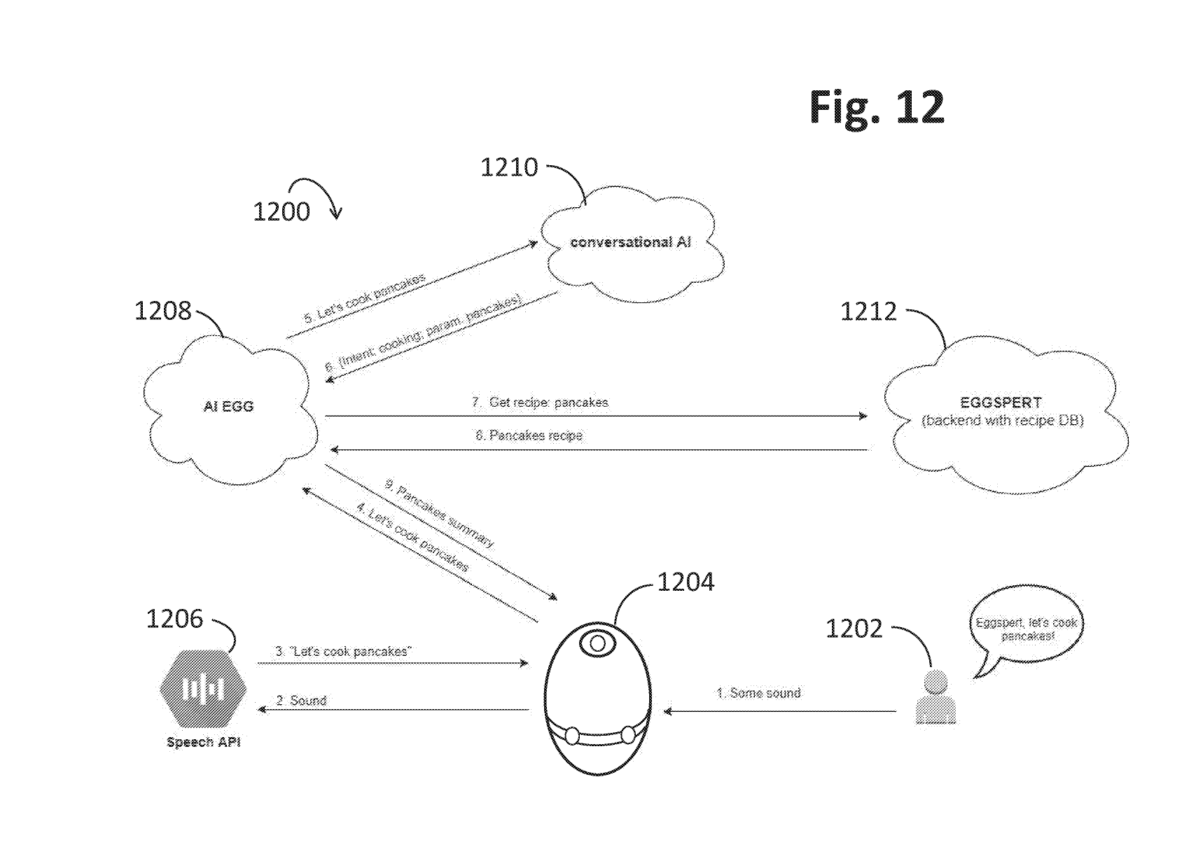

FIG. 12 represents a communications schema 1200 that permits embodiments of the present invention to hear and understand a user 1202 and provide them with what they've requested. A combination of artificial intelligence (AI) and application programming interfaces (API) are called on in sequence. For the most part, these functions are remote and connected wirelessly through a server and thus can support thousands of users and devices. Suppose a user 1202 speaks “Let's cook pancakes.” All device 1204 receives is “1. Some sound”, since the device 1204 itself is not intelligent. A recording of the sounds are sent as a file to a speech API 1206. This then converts the sound to text, e.g., “3. Let's cook pancakes.” But device 1204 still doesn't “understand” and forwards the text to AI Egg 1208, an AI tailored to provide recipes to cooks. The text is forwarded to an API.AI 1210 that makes sense of the phrase. That sense is parsed as “6. {Intent: cooking; param.pancakes}”. Now that AI EGG 1208 has the intent, e.g., pancakes, it can forward a request “7. Get recipe: pancakes” to a backend recipe database 1212 that supplies “8. Pancakes recipe”.

AI Egg 1208 converts this to “9. Pancakes summary” for device 1204 to display to the user 1202. The user 1202 can then be walked through the preparation with more voice interaction and interpretation.

Referring to FIG. 12, below is a detailed description of the method of cooking assistance provided by the multi-functional intelligent personal assistant device (HelloEgg). Step 1: User sends voice command to HelloEgg; Step 2: HelloEgg streams sound of user's voice command to Speech API via Internet; Step 3: Speech API converts recorded sound to text and sends it back to HelloEgg; Step 4: HelloEgg sends text to AI EGG via Internet; Step 5: AI EGG sends text to conversational AI, a service that understands a context of the request (i.e. whether a user wants to cook something, needs to order or just initiates a small talk); Step 6: Conversational API AI analyses type of request and sends it depending on a predetermined set of rules: (a) If conversational AI recognizes text as executable request related to recipes then it sends it back to AI EGG with appropriate marking (context=cooking), (b) If conversational AI recognizes text as executable request related to other topic (taxi calling, placing a grocery order etc.) it sends it back to AI EGG with appropriate marking, (c) If conversational AI didn't recognize text as executable request it sends text to Human Assistance (Operator), not shown at the communication scheme above, (d) Human Assistance (Operator) may either choose a proper context/enforce executable request instead of conversational AI (then the system goes to step 7) or manually enter a response (then system goes to step 10); Step 7: AI EGG sends request for a recipe to the database with recipes (EGGSPERT) and other requests to a predefined third party services; Step 8: EGGSPERT (or other third party) sends respective recipe or other information to AI EGG; Step 9: AI EGG sends text with recipe or other information to HelloEgg; Step 10: HelloEGG receives text (response on a question, recipe, other information from a third party service) and start processing via text-to-speech processor; Step 11: Text-to-speech processor plays sound from text with a response or recipe and shows picture if one exists.

Please note: Speech API and conversational AI—are a third-party server(s)/system(s), while AI EGG and EGGSPERT are parts of HelloE Server

Embodiments of the present invention are not limited to providing recipes and cooking instructions to users preparing foods. For example, kit assembly instructions, user operation manuals, certified maintenance procedures, pre-approved emergency procedures, disaster escape plans, weapons loading, bank procedures, driving instruction, etc. A third party can be the one to launch the action, e.g., “Let's cook pancakes”, or the third party can be the one to receive the pancake recipe and preparations instructions.

Although particular embodiments of the present invention have been described and illustrated, such is not intended to limit the invention. Modifications and changes will no doubt become apparent to those skilled in the art, and it is intended that the invention only be limited by the scope of the appended claims.

1. A multi-functional intelligent personal assistant device responsive to spoken requests for assistance and information from a user, comprising:
an egg-shaped main body having a shell that encloses inside at least one microcomputer, audio subsystem, video display subsystem, sensor subsystem, movement control electro-mechanical subsystem, internal bus, power source, wireless transceiver that supports connections with the Internet, and plurality of interconnections;
wherein the main body has a rounded bottom end and a low center of gravity in the bottom end so as to assume an upright position when leveled;
wherein the movement control electro-mechanical subsystem is operative to respond to control of the microcomputer and includes at least one rotation control system;
wherein the rotation control system enables the device to rotate on its axis;
wherein the rotation control system includes at least one rotation motor mounted to at least one rotor ring and a set of gears to rotate the device on its axis; and
wherein the sensor subsystem includes at least one user detection system having a plurality of passive infrared sensors (PIT) and accelerometer to control tilt of the device.

2. The multi-functional intelligent personal assistant device of claim 1, wherein the movement control electro-mechanical subsystem operative to respond to control of the microcomputer further comprises:
at least one tilt control system, wherein the tilt control system enables the device to tilt left, right, fore and aft; and
wherein the tilt control system includes at least a pair of sliding gear motors and at least a pair of ballast weights to tilt the device left, right, fore and aft by manipulating a center of gravity (COG) of the main body of the device.

3. The multi-functional intelligent personal assistant device of claim 1, further comprising:
at least one microphone and at least one speaker included in the audio subsystem, wherein at least one microphone is operative to receive spoken words from the user, and at least one speaker is operative to produce verbal responses, music, and sounds to the user;
wherein words and phrases spoken by the user are recorded into audio files by the microcomputer and audio subsystem, and then transmitted wirelessly to servers on the Internet for understanding and responding back to the user using artificial intelligence (AI) processors and commercial application program interfaces (API).

4. The multi-functional intelligent personal assistant device of claim 3, further comprising:
an animation program control of the microcomputer that causes real-time visual changes of the device to be displayed to the user;
wherein the visual changes comprise a cartoon animation shown on the video display of the device, and changes to the COG of the device such that the device tilts left, right, fore or aft.

5. The multi-functional intelligent personal assistant device of claim 3, further comprising:
a video display program control of the microcomputer that transmits digital pictures, graphics, text, photos, and/or videos through the video display subsystem as a response to a spoken command of the user.

6. The multi-functional intelligent personal assistant device of claim 1, further comprising:
the COG of the main body is within two to three centimeters from a bottom end of the device and is such that the whole stands up at attention on the bottom end when laid on a flat surface; and
wherein, the COG is adjustable under program control of the microcomputer through the movement control electro-mechanical subsystem.

7. The multi-functional intelligent personal assistant device of claim 3, further comprising:
a plurality of passive infrared sensors (PIR) and a plurality of far-field microphones that are dispersed around the circumference of the device; and
at least one pinhole camera with infrared cut-off filter (IR filter).

8. The multi-functional intelligent personal assistant device of claim 1, further comprising:
a speech recognition sorter that redirects speech recognition requests and audio files to a human concierge whenever artificial intelligence fails a speech recognition task.

9. The multi-functional intelligent personal assistant device of claim 1, further comprising:
a spherical or ellipsoidal or egg-shaped body with a hard bottom surface configured to roll on a flat level surface;
a center-of-gravity positioning subsystem mounted inside the body that is operable to control any of the static yaw, pitch, and roll of the body and to stabilize its position on a flat level surface;
a sound subsystem with plurality of speakers and microphones mounted inside the body that reproduce voices, music, and sound effects audible to a user, and capture speech spoken by the user;
a speech recognition and processing subsystem at least partially disposed in the body and connected to the sound subsystem to extract machine commands from the speech spoken with artificial intelligence methods; and
a display subsystem disposed inside an upper half of the body to show the user a variety of animations, graphics, text, photos, and videos on the video display of the device.

10. A multi-functional intelligent personal assistant device responsive to spoken requests for assistance and information from a user, comprising:
an egg-shaped main body having a shell that encloses inside at least one microcomputer, audio subsystem, video display subsystem, sensor subsystem, movement control electro-mechanical subsystem, internal bus, battery, battery charger, wireless transceiver that supports connections with the Internet, and plurality of interconnections;
wherein the main body has a rounded bottom end and a low center of gravity in the bottom end so as to assume an upright position when leveled;
wherein the movement control electro-mechanical subsystem is operative to respond to control of the microcomputer and includes at least one rotation control system and at least one tilt control system;
wherein the rotation control system enables the device to rotate on its axis and the tilt control system enables the device to tilt left, right, fore and aft;
wherein the rotation control system includes at least one rotation motor mounted to at least one rotor ring and a set of gears to rotate the device on its axis;
wherein the tilt control system includes at least a pair of sliding gear motors and at least a pair of ballast weights to tilt the device left, right, fore and aft by manipulating a center of gravity (COG) of the main body of the device;
wherein the sensor subsystem includes at least one user detection system having a plurality of passive infrared sensors (PIT);
at least one microphone and at least one speaker included in the audio subsystem, wherein at least one microphone is operative to receive spoken words from the user, and at least one speaker is operative to produce verbal responses, music, and sounds to the user, wherein words and phrases spoken by the user are recorded into audio files by the microcomputer and audio subsystem, and then transmitted wirelessly to servers on the Internet for understanding and responding back to the user using artificial intelligence (AI) processors and commercial application program interfaces (API) and accelerometer to control tilt of the device;
an animation program control of the microcomputer that causes real-time visual changes of the device to be displayed to the user, wherein the visual changes comprise a cartoon animation shown on the video display of the device, and changes to the COG of the device such that the device tilts left, right, fore or aft;
a video display program control of the microcomputer that transmits digital pictures, graphics, text, photos, and/or videos through the video display subsystem as a response to a spoken command of the user; and
a speech recognition sorter that redirects speech recognition requests and audio files to a human concierge whenever artificial intelligence fails a speech recognition task.

11. A countertop device responsive to spoken requests for assistance and information from a user, comprising:
a main body generally in the shape of an egg or ellipsoid, and having a shell that encloses its interior volume, and including a rounded bottom for resting in contact with a flat countertop, wherein a center-of-gravity (COG) results inside the rounded bottom that is proximate to the contact and maintains the vertical position of the device even if the device is tilted;
a sound subsystem with amplifiers and speakers disposed within the main body, and configured to reproduce and output voices, music, and sound effect audible to the user;
at least one microphone and encoders disposed within the main body or on the surface of the device, and configured to record speech spoken by the user for the following processing and speech recognition, and
a video display subsystem disposed within the main body, and configured to project video images that are backlit on the surface of the shell, and to inform and entertain the user;
a wireless communication subsystem with a transceiver disposed within the main body, and configured to support network connections with the Internet
a microcomputer connected and programmed to control and coordinate the electromechanical, sound, speech recognition/processing, video display, and wireless communication subsystems in a variety of ways that entertain and respond to spoken requests for assistance and information from a user;
wherein, the speech recognition/processing subsystem is at least partially disposed in the main body and is connected to the sound subsystem to extract machine commands from speech spoken by the user for artificial intelligence processing in the cloud; and
wherein, words and phrases audibly spoken by the user are recorded into audio files by the microcomputer and audio subsystem, and then transmitted wirelessly to servers on the Internet for machine understanding and response back to the user.

12. The countertop device of claim 11, further comprising:
a tilt sensor to internally detect an externally forced tilting of the main body away from its resting contact on the countertop; and
a control device internally connected to the tilt sensor and allowing operations of the device by the signal from the sensor.

13. The countertop device of claim 11, further comprising:
a speech translator for converting spoken user requests from recorded audio files to text files;
an artificial intelligence processor tasked to do speech recognition;
a human concierge console; and
a user request sorter that redirects the text files to the human concierge console whenever the artificial intelligence processor fails in speech recognition task.

14. The countertop device of claim 11, further comprising:
an animation control program for execution by the microcomputer and the electromechanical subsystem that coordinates changes to the position of the COG, and thus the attitude assumed by the main body on the countertop, as part of an audio and video response back to a request spoken by the user that animatronically imparts a personality and life to entertain the user.

15. The countertop device of claim 11, further comprising:
a video display control program for execution by the microcomputer to send digital pictures and video clips through the video display subsystem as part of a response back to a request spoken by the user predetermined to inform, instruct, and entertain the user.

16. The countertop device of claim 11, further comprising:
a camera disposed within the main body, and configured to support video calls over an Internet connection with the wireless transceiver to a remote user.

17. The countertop device of claim 11, further comprising:
a battery disposed within the main body and charger (wire or wireless), and configured to provide operational power to the other components.

18. The countertop device of claim 11, further comprising:
a sensor subsystem disposed within the main body or on its surface, and configured to detect any motion consistent with the user in the area around the intelligent countertop device.

19. The countertop device of claim 11, further comprising:
an electromechanical subsystem of motors, gears, and adjustable weights configured to affect changes in the lateral position of the COG within the rounded bottom such that the main body can be electronically controlled to lean forward, backward, left or right and stay there on another point of contact with the flat countertop.
